(19) United States
(12) Patent Application Publication
(10) Pub. No.: US 2010/0095132 A1
(43) Pub. Date: Apr. 15, 2010

(54) PROTECTING SECRETS IN AN UNTRUSTED RECIPIENT

(75) Inventor: Eric Murray, Los Gatos, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: SafeNet, Inc., Belcamp, MD (US)

(21) Appl. No.: 12/448,583

(22) PCT Filed: Jan. 28, 2008
(86) PCT No.: PCT/US08/52230

§ 371 Date: Jun. 24, 2009

Related U.S. Application Data
(60) Provisional application No. 60/897,783, filed on Jan. 26, 2007.

(51) Int. Cl. G06F 21/24

(52) U.S. Cl. 713/189; 726/26

(57) ABSTRACT

A technique for protecting secrets may involve enclosing master secret keys in an encapsulation module functioning like an envelope on a host that may run an untrusted operating system. The encapsulation module itself can be obfuscated and protected with various software security techniques, such as anti-debugging techniques, which make reverse-engineering more difficult. Session or file keys could then be derived from the master key stored in the encapsulation module on the host, wherein each of the keys protects a session or a file on the host. Additionally, a code can be provided to prevent the master secret and the keys from being swapped to a non-volatile storage device of the host.

### BACKGROUND

For some systems, it is required to distribute secrets to less secure (“untrusted”) recipients. For example, a host may be trusted to receive keys, but is running an untrusted operating system. An untrusted operating system for the purposes of this paper is one which an attacker can access, run software on, and possibly gain elevated privilege on. Commercial operating systems could be considered untrusted in most settings.

Distributing secrets securely is a solved problem. However, security risks are introduced when the secret arrives on an untrusted recipient and is decrypted. A secret residing in a program is easy for an attacker to read. The attacker, after elevating his privileges sufficiently, for example, can for example read the secret from swap space or program process memory.

These are but a subset of the problems and issues associated with untrusted recipients, and are intended to characterize weaknesses in the prior art by way of example. The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for protecting secrets may involve enclosing master secret keys in an encapsulation module functioning like an envelope on a host that may run an untrusted operating system. The encapsulation module itself can be obfuscated and protected with various software security techniques, such as anti-debugging techniques, which make reverse-engineering more difficult. Session or file keys could then be derived from the master key stored in the encapsulation module on the host, wherein each of the keys protects a session or a file on the host. Additionally, a code can be provided to prevent the master secret and the keys from being swapped to a non-volatile storage device of the host.

The proposed system can offer, among other advantages, secrets that are reasonably well protected even on untrusted recipients. This and other advantages of the techniques described herein will become apparent to those skilled in the art upon a reading of the following descriptions and a study of the several figures of the drawings.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts an example of a system 100 to support protection of secrets in an untrusted environment.

FIG. 2 depicts a flowchart 200 of an example of a method to support protection of secrets in an untrusted environment.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

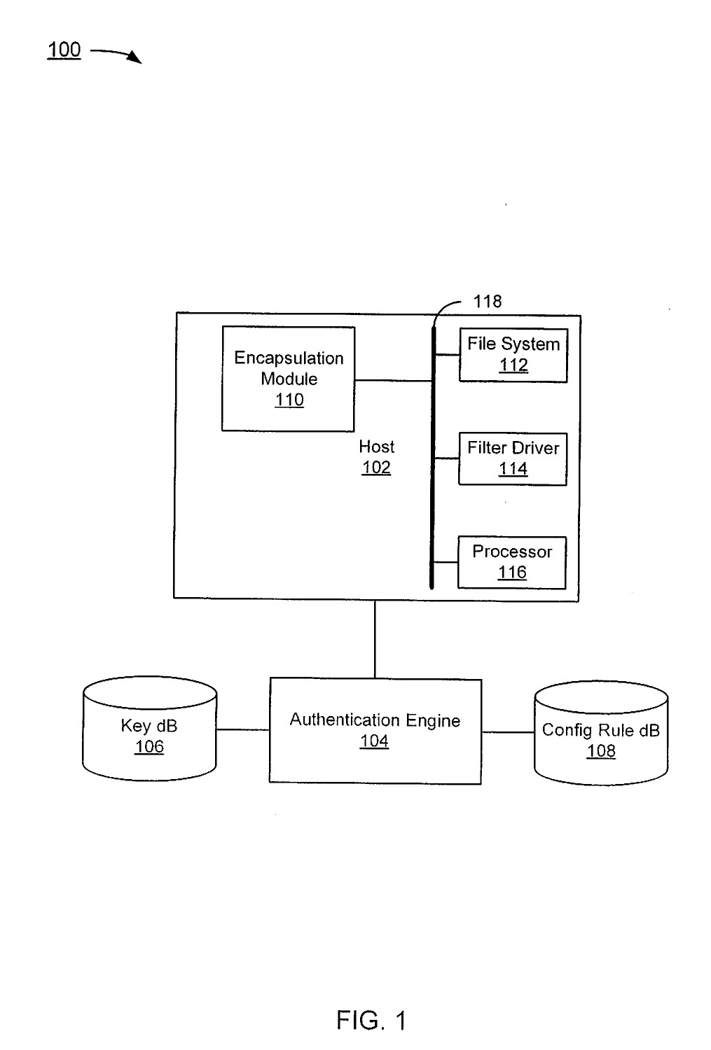

FIG. 1 depicts an example of a system 100 to support protection of secrets in an untrusted environment. The system 100 includes a host 102, an authentication engine 104, a key database 106, and a config rule database 108, and an encapsulation module (envelope) 110 that contains at least a master secret (key) at the host 102.

The host 102 may include any known or convenient computer system. The host 102 may function as a file server or have some other functionality. In an illustrative embodiment, the host 102 includes a file system 112, a filter driver 114, and a processor 116 coupled to a bus 118. The functionality of the file system 112, filter driver 114, processor 116, and bus 118 are well-known in the relevant art, so a detailed description of these components is deemed unnecessary. It may be noted that bus-less architectures may be used in alternative embodiments.

Conceptually, the filter driver 114 is inserted, as part of the operating system, between the file system 112 and a process that will use files from the file system 112. The filter driver 114 applies the configuration rules provided from the config rule database 108 by the authentication engine 104. The configuration rules may include, by way of example but not limitation, a rule that everything in a first directory is to be encrypted using a first key provided from the key database 106 by the authentication engine 104. (Alternatively, the first key could be generated locally or received from some place other than the key database 106.) As another example, the configuration rules may include a rule that a first user receives encrypted data (e.g., cipher text) when accessing a particular file.

In an illustrative embodiment, the host 102 is a less secure (“untrusted”) system than, for example, the authentication engine 104. The host 102 is sufficiently trusted that it can receive keys, but, for example, may be running an untrusted operating system. Consequently, a master secret should never be put “in the clear” on the host 102. Other keys, such as keys derived from the master key, may be used in the clear on the host 102, if the security risk is considered sufficiently low.

In an illustrative embodiment, the encapsulation module 110 can be a software, firmware, hardware, or combination thereof running on the host 102. The encapsulation module 110 can function like an “envelope”, which is operable to enclose, maintain, and protect the master secret, the code used to receive and decrypt an encrypted master secret (e.g., for exchange from another host or from reading a file), and the code used to generate session keys from the master secret. The encapsulation module 110 itself (and the code included therein) may be obfuscated and protected with various software security techniques, such as anti-debugging techniques, which makes reverse-engineering more difficult.

It may be noted that perfect protection is not possible on an untrusted host. Therefore, security techniques typically involve making it more difficult to crack the security. One advantage of the encapsulation module 110 is that all security-sensitive codes and/or secrets are all in the encapsulation module 110, so, at least to some extent, only the encapsulation module 110 needs to be protected against attack.

In an illustrative embodiment, session or file keys are derived or generated from the master key stored in the encapsulation module 110. Since they protect only one session or file, the session or file keys are of lower value and can be used, if the security risk is deemed to be low enough, directly without being stored in the encapsulation module 110. An alternative to deriving session keys would be to generate random session keys in the encapsulation module 110 and encrypt them with the master key for storage. With this alternative, the encapsulation module 110 may include code to decrypt encrypted session keys on request.

In an illustrative embodiment, the encapsulation module 110 can further include, maintain, and protect a code used to prevent the master secret and the session or file keys from being swapped to a non-volatile storage device of the host 102, such as a disk. In addition, the encapsulation module may obfuscate the master secret key and/or the code to prevent them from being read directly from a volatile storage device of the host 102, such as a memory. In an illustrative embodiment, all of the codes in the encapsulation module are obfuscated to make deciphering its operation more difficult.

The authentication engine 104 may include any known or convenient computer system. The authentication engine 104 may or may not be implemented as an appliance that is coupled to the host 102, or as some other device or computer coupled to the host 102 through, e.g., a network connection. The authentication engine 104 provides master secret keys and configuration rules from the key database 106 and the config rule database 108, respectively, to the host 102. The term “engine,” as used herein, generally refers to any combination of software, firmware, hardware, or other component that is used to effectuate a purpose.

The authentication engine 104 may be administered by the same admin as administers the host 102. Alternatively, an admin may be responsible for administering the authentication engine 104, and a lower level administrator may be responsible for administering the host 102. The latter would be more typical in a relatively large enterprise. It may be noted that the administrator of the authentication engine 104 might be able to crack at least some of the security of the host 102 (since the admin of the authentication engine 104 has access to the keys and encryption rules provided to the host 102), but the reverse is not necessarily true.

In an illustrative embodiment, the keys database 106 includes master secrets that may or may not be encrypted. However, in an illustrative embodiment, the master secrets are either encrypted and stored in the keys database 106, or encrypted prior to sending to the host 102 by the authentication engine 104. In an illustrative embodiment, an encrypted master secret is provided via an SSL connection between a secure key server (e.g., the authentication engine 104) and a recipient (e.g., the host 102). The encryption serves to protect the master secret between the SSL stack and insertion into the encapsulation module 110. When the encapsulation module 110 receives the encrypted master key, it decrypts it appropriately (e.g., using an obfuscated compiled-in symmetric key or code, or an RSA key).

In an illustrative embodiment, the master key could be provided in some other manner than from a secure key server. For example, the master key could be provided to the host 102 on a portable storage device such as a USB disk. Providing the master secret on a disk is probably less secure than providing the master secret through, e.g., and SSL connection from a secure key server. However, the exact manner in which the key is received is an implementation-specific choice.

In the example of FIG. 1, in operation, the authentication engine 104 provides a master secret key, which can be managed and stored in the key database 106, to the encapsulation module 110 running on the host 102, which may not be secured enough to store the master secret key in “clear air.” The encapsulation module 110 then encloses, maintains, and protects the master secret key on the host, where the encapsulation module itself can be obfuscated and protected with various security techniques. Besides the master secret key, the encapsulation module 110 may also enclose all security-sensitive codes and secret keys on the host, including a code used to accept and decrypt the master secret key on the host if the master secret key is encrypted. In addition, the encapsulation module 110 can generates one or more session or file keys from the master secret key, each of which protects a session or a file on the host.

In an illustrative embodiment, the encapsulation module 110 may be generated and initialized, by way of example but not limitation, via the following call to an Application Programming Interface (API):

Encapsulation_module envelope=new encapsulation_module(EncryptedMasterKey);

When the encapsulation module 110 receives the encrypted master key EncryptedMasterKey, it decrypts the encrypted master key appropriately.

In an illustrative embodiment, a session (or file) key may be generated from the encapsulation module 110, by way of example but not limitation, using the following function call from the encapsulation module:

SessionKey key=envelope·generate(FileOrDocumentldentifier);

where SessionKey may be used to encrypt or decrypt the file and FileOrDocumentldentifier may be a fixed public value such as a file name.

In an illustrative embodiment, the encapsulation module 110 may obfuscate the encrypted master secret (key) by moving it to a specific memory location—pinned memory, decrypting the encrypted master secret at the pinned memory if necessary, and then obfuscating the specific memory location as follows. By way of example but not limitation, the following functions can be invoked by the encapsulation module 110:

ObtainPinnedMemory( )

Move(EncryptedMasterKey, PinnedMemory)

ObfuscatedMasterKeyDecrypt(PinnedMemory)

Obfuscate(PinnedMemory)

In an illustrative embodiment, the encapsulation module 110 may retrieve the master secret from the pinned memory by de-obfuscating the pinned memory and then hashing the master secret out of the memory location:

DeObfuscate(PinnedMemory)

key=Hash(PRF(FileOrDocumentIdentifier), PinnedMemory)

Obfuscate(PinnedMemory)

return key

where PRFO may be a pseudo-random function and Hash( ) may be a non-reversible cryptographic hash.

The examples shown in the previous few paragraphs illustrate an implementation of an encapsulation module. One of skill in the relevant art would be able to expand the teachings to include a number of different implementations for encapsulation module generation and management. It should be noted that this simple illustration has a drawback of having the master key in the clear for the Hash( ) operation. So an attacker who could dump the process memory at the correct time could find the master key. A more sophisticated implementation would combine the de-obfuscation and key derivation functions so that the master key was masked at all times or only part of it was unmasked at a given time. The simple illustration was chosen simply to convey important concepts without complicating the picture.

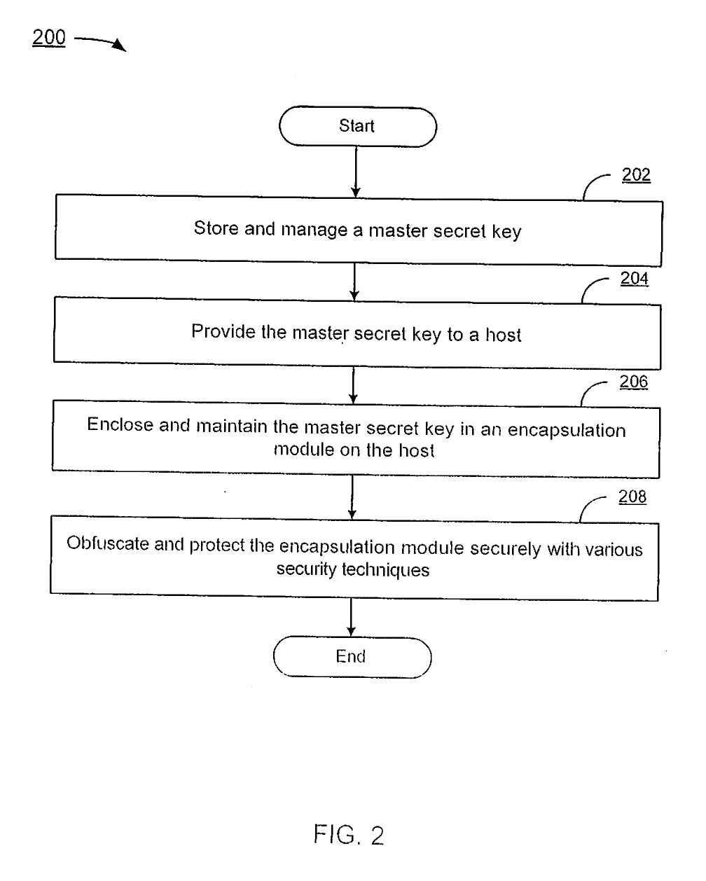

FIG. 2 depicts a flowchart 200 of an example of a method to support protection of secrets in an untrusted environment. This method and other methods are depicted as serially arranged modules. However, modules of the methods may be reordered, or arranged for parallel execution as appropriate.

In the example of FIG. 2, the flowchart 200 starts at module 202 where a master secret key is stored and managed securely. Here, the master secret key can either be stored securely in a key database on a secure server or on a portable storage device, which can be but is not limited to, a smart card, a USB drive, or a portable disk drive.

In the example of FIG. 2, the flowchart 200 continues to module 204 where the master secret key is provided to a host. Here, the master secret key can be encrypted prior to being sent to the host via an SSL connection between the secure server where the master secret has been stored and the recipient—the host. If the master secret key is accepted at the host in its encrypted form, it will be decrypted appropriately via code or key.

In the example of FIG. 2, the flowchart 200 continues to module 206 where the master secret key is enclosed and maintained securely on the host. More specifically, the master secret key can be enclosed in an envelope-like encapsulation module running on the host. In practice, all security-sensitive codes and/or secret keys can be kept together in the encapsulation module such that only one centralized data management component on the host needs to be protected from potential attacks, making protection on the unsecured host easier.

In the example of FIG. 2, the flowchart 200 ends at module 208 where the encapsulation module itself can be obfuscated and protected securely on the host with various software security techniques. Here, such software security techniques include but are not limited to, anti-debugging techniques, which are often used to prevent hackers or intruders from using software debugging tools to break into the content (e.g., keys and codes) enclosed in a software module.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and techniques described herein also relate to apparatus for performing the algorithms and techniques. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A system, comprising:
a host;
an authentication engine, which while in operation, provides a master secret key to the host;
an encapsulation module running on the host, which while in operation, encloses, maintains, and protects the master secret key on the host, wherein the encapsulation module itself is obfuscated and protected with various security techniques.

2. The system of claim 1, further comprising:
a key database operable to manage and store the master secret key.

3. The system of claim 1, wherein:
the host is an unsecured or untrusted system.

4. The system of claim 1, further comprising:
a encryption rule database operable to manage and store one or more encryption rules.

5. The system of claim 4, wherein:
the authentication engine provides the one or more encryption rules to the encapsulation module.

6. The system of claim 1, wherein:
the authentication engine encrypts the master secret key before providing it to the host.

7. The system of claim 6, wherein:
the encapsulation module encloses, maintains, and protects a code used to accept and decrypt the master secret key on the host if the master secret key is encrypted.

8. The system of claim 1, wherein:
the encapsulation module encloses, maintains, and protects all security-sensitive codes and secret keys on the host.

9. The system of claim 8, wherein:
the encapsulation module obfuscates the keys and the codes to prevent them from being read directly from a volatile storage device.

10. The system of claim 1, wherein:
the encapsulation module generates one or more session or file keys from the master secret key stored in the encapsulation module.

11. The system of claim 10, wherein:
each of the one or more session or file keys protects a session or a file on the host.

12. The system of claim 1, wherein:
the encapsulation module generates one or more session or file keys randomly and encrypts them with the master key stored in the encapsulation module.

13. The system of claim 1, wherein:
the encapsulation module encloses, maintains, and protects a code used to prevent the master secret key and the one or more session or file keys from being swapped to a non-volatile storage device.

14. A method, comprising:
storing and managing a master secret key;
providing the master secret key to a host;
enclosing and maintaining the master secret key in an encapsulation module on the host;
obfuscating and protecting the encapsulation module securely with various security techniques.

15. The method of claim 14, further comprising:
encrypting the master secret key before providing it to the host.

16. The method of claim 15, further comprising:
enclosing, maintaining, and protecting a code used to accept and decrypt the master secret key on the host if the master secret key is encrypted.

17. The method of claim 14, further comprising:
enclosing, maintaining, and protecting all security-sensitive codes and secret keys on the host.

18. The method of claim 17, further comprising:
obfuscating the keys and the codes to prevent them from being read directly from a volatile storage device.

19. The method of claim 14, further comprising:
generating one or more session or file keys from the master secret key.

20. The method of claim 14, further comprising:
storing and managing one or more encryption rules;
providing the one or more encryption rules to the host.

21. The method of claim 20, further comprising:
generating one or more session or file keys randomly and encrypting them with the master key based on the one or more encryption rules.

22. The method of claim 14, further comprising:
including, maintaining, and protecting a code used to prevent the master secret key and one or more session or file keys from being swapped to a non-volatile storage device.

23. A system, comprising:
means for storing and managing a master secret key;
means for providing the master secret key a host;
means for enclosing and maintaining the master secret key in an encapsulation module on the host;
means for obfuscating and protecting the encapsulation module securely with various security techniques.
